(19) United States
(12) Patent Application Publication
(10) Pub. No.: US 2010/0207422 A1
(43) Pub. Date: Aug. 19, 2010

(54) STOWABLE VEHICLE SEAT

(75) Inventor: Tatsuo Sayama, Tochigi (JP)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: TS Tech Co., Ltd., Saitama (JP)

(21) Appl. No.: 12/682,116

(22) PCT Filed: Oct. 9, 2008
(86) PCT No.: PCT/JP2008/068387

§ 371 Date: Apr. 8, 2010

(30) Foreign Application Priority Data
Oct. 9, 2007 (JP) 2007-263228

(51) Int. Cl. B60N 2/36; B60N 2/30

(52) U.S. Cl. 296/66

(57) ABSTRACT

There is provided a stowable vehicle seat having improved operability. This seat includes a seat support part for rotatably supporting one end part side of a seat cushion, and a seat back that is foldable over the seat cushion via a reclining mechanism. The reclining mechanism includes a spiral spring for urging the seat back to fold the back to the seat cushion side with a predetermined angle with respect to the seat cushion, a first locking part disposed in a raised state on the cushion side of a connecting part between the cushion and the seat back to lock one end part side of the spiral spring, and a second locking part disposed in a raised state on the seat back side of the connecting part between the cushion and the back to lock the other end part side of the spiral spring to the seat back side.

### CROSS-REFERENCE TO RELATED APPLICATIONS

This application is the U.S. national phase of the International Patent Application No. PCT/JP2008/068387 filed Oct. 9, 2008, which claims the benefit of Japanese Patent Application No. 2007-263228 filed Oct. 9, 2007, the entire content of which is incorporated herein by reference.

### BACKGROUND

Various embodiments of the present invention relates to a stowable vehicle seat and, more particularly, to a stowable vehicle seat having improved operability.

Conventionally, there has been known a stowable vehicle seat in which in the state in which the rear end part of a seat cushion constituting a vehicle seat is supported to be rotatable in the front and rear direction on the front side of a stowage recess (storage recess) in vehicle body floor, and a seat back is folded over the seat cushion, the vehicle seat can be rotated to the rear and stowed in the stowage recess.

For example, as disclosed in Japanese Unexamined Patent Application Publication No. 2006-82698 (“the '698 Publication”), there are provided rotating shafts provided in both right and left side edge parts in the front part of the stowage recess and brackets provided in right and left parts of the rear end part of the seat cushion, and the brackets are disposed to be rotatable in the front and rear direction with respect to the rotating shafts, whereby the seat can be stowed in the stowage recess by supporting the rear end part of the seat cushion to be rotatable in the front and rear direction.

On the other hand, according to the technique described in the '698 Publication, a spiral spring for urging the seat back to the fold direction is mounted to a reclining lock (reclining mechanism) for rotating the seat back with respect to the seat cushion. Therefore, at the seat stowing operation time when the seat back is folded over the seat cushion and is brought down, there arises a disadvantage that a shock occurs and shock noise is produced when the urged seat back is folded over the seat cushion. Also, if the seat back is folded during the seat stowage rotating, there arises a disadvantage that the rotating speed is accelerated by the shock at the folding time.

Further, there arises a disadvantage that in particular, the raising operation for raising the seat back from the folded-down state is difficult to perform because the pull height of a strap and the height of the rotating shaft of seat back are close to each other, so that the pulling-up load of the seat back is high.

### SUMMARY

Various embodiments of the present invention have been made to solve the above problems, and accordingly an object thereof is to provide a stowable vehicle seat in which a shock occurring at the folding time of the seat back is buffered, and thereby a sense of security at the time of seat operation and the commodity quality of seat are improved.

Another object is to provide a stowable vehicle seat in which a reduction in operation load is achieved.

To achieve the above objects, the stowable vehicle seat according to an embodiment includes a seat support for rotatably supporting one end part side of a seat cushion; and a seat back that is foldable over the seat cushion via a reclining assembly, the reclining assembly including an urging element for urging the seat back to fold the seat back to a seat cushion side with a predetermined angle with respect to the seat cushion; a first locking part disposed in a raised state on the seat cushion side of a connecting part between the seat cushion and the seat back to lock one end part side of the urging element; and a second locking part disposed on the seat back side of the connecting part between the seat cushion and the seat back to lock the other end part side of the urging element to the seat back side.

It is preferable that the first locking part and the second locking part each have a groove part formed in the axial direction of the reclining assembly; and one end part side of the urging element be locked to the groove part of the first locking part, and the other end part side thereof be locked to the groove part of the second locking part.

Thus, the reclining assembly is configured to have the urging element for urging the seat back to fold the seat back to the seat cushion side with a predetermined angle with respect to the seat cushion; the first locking part disposed in a raised state on the seat cushion side of the connecting part between the seat cushion and the seat back to lock one end part side of the urging element; and the second locking part disposed on the seat back side of the connecting part between the seat cushion and the seat back to lock the other end part side of the urging element to the seat back side, and the end parts of the urging element are locked to the groove parts formed in the first locking part and the second locking part against the rotating in any direction. Therefore, the predetermined angle of tilt of the seat back with respect to the seat cushion in the state in which the locking of the reclining mechanism is released can be set optionally. That is to say, the fall-down angle of the seat back raised slightly from the fall-down state can be set as the neutral position. Therefore, a shock occurring when the seat back is folded over the seat cushion can be reduced, and also the operation load of the operation for raising the seat back with respect to the seat cushion can be reduced, so that high operability can be assured.

The configuration is preferably made such that the urging element is provided on both sides in the side surface direction of the seat back, and one side of the urging element is urged to the frontward rotating direction, and the other side thereof is urged to the rearward rotating direction.

Since one side of the urging element provided on both sides at the right and left in the side surface direction of the seat back is urged to the frontward rotating direction, and the other side thereof is urged to the rearward rotating direction as described above, the seat back fall-down angle in the state in which the urging forces of the right and left urging element are balanced can be set as a neutral position. By making the seat back fall-down angle a state of raising slightly from the fall-down state, a shock occurring when the seat back is folded over the seat cushion can be reduced. Also, the operation load of the operation for raising the seat back with respect to the seat cushion can be reduced, so that high operability can be assured.

The configuration is preferably made such that the urging element comprises a plurality of urging springs, and the urge directions of the plurality of urging springs are different.

Since the configuration is made such that the urge directions of the plurality of urging springs mounted to the urging element are not the same as described above, the seat back fall-down angle in the state in which the urging forces of the right and left urging element are balanced can be set as the neutral position. By making the neutral position a seat back fall-down angle of raising slightly from the fall-down state, a shock occurring when the seat back is folded over the seat cushion can be reduced. Also, the operation load of the operation for raising the seat back with respect to the seat cushion can be reduced, so that high operability can be assured.

The predetermined angle is preferably set at 15 to 30 degrees. By setting the predetermined angle of the seat back fall-down angle in the neutral position at 15 to 30 degrees, a shock occurring when the seat back is folded over the seat cushion can be reduced. Also, the operation load of the operation for raising the seat back with respect to the seat cushion can be reduced, so that high operability can be assured.

According to the stowable vehicle seat in accordance with various embodiments of the present invention, by mounting the urging element for urging the seat back to fold the seat back to the seat cushion side with the predetermined angle to the reclining mechanism, a shock occurring when the seat back is folded over the seat cushion can be buffered. By the buffering of shock, shock noise at the time of folding is reduced, and a sense of security at the seat arrangement time can be improved.

Also, the acceleration of rotating speed caused by the shock at the time when the seat back is folded over the seat cushion during the stowage rotating of the seat can be prevented.

Further, since the raising operation performed by the pulling of strap can be conducted from the state in which the seat back is tilted with the predetermined angle with respect to the seat cushion, the operation load can be reduced.

### BRIEF DESCRIPTION OF THE DRAWINGS

Embodiments of the invention are illustrated in the following drawings and described in more detail below.

FIG. 1 is a schematic side view of a vehicle rear part equipped with a stowable vehicle seat in accordance with an embodiment of the present invention;

FIG. 2 is a front perspective view of a stowable vehicle seat in accordance with one embodiment of the present invention;

FIG. 3 is a rear perspective view of a stowable vehicle seat in accordance with one embodiment of the present invention;

FIG. 4 is a schematic perspective view of a seat frame in accordance with one embodiment of the present invention;

FIG. 5 is an enlarged explanatory perspective view of a seat support part in accordance with one embodiment of the present invention;

FIGS. 6A, 6B are enlarged explanatory front and side views of a reclining mechanism in accordance with one embodiment of the present invention;

FIG. 7 is an explanatory side view of a seat back fall-down angle and an operation load in accordance with one embodiment of the present invention;

FIG. 8 is an enlarged explanatory side view of a link mechanism in accordance with one embodiment of the present invention;

FIG. 9 is a sectional explanatory view of a link mechanism in accordance with one embodiment of the present invention, the view being taken along the line I-I of FIG. 8;

FIG. 10 is a schematic explanatory side view of a locking part of a front leg in accordance with one embodiment of the present invention;

FIG. 11 is a schematic explanatory side view of a link mechanism at the time of folding of a seat back in accordance with one embodiment of the present invention;

FIG. 12 is a sectional explanatory view of a link mechanism in accordance with one embodiment of the present invention, the view being taken along the line II-II of FIG. 11;

FIG. 13 is a schematic explanatory side view of a stowage locking part in accordance with one embodiment of the present invention;

FIGS. 14A-14F are explanatory side views showing an operation procedure at the time of stowing operation of a stowable vehicle seat in accordance with one embodiment of the present invention;

FIGS. 15A-15C are explanatory side views for explaining operation of a link mechanism at the time of stowing operation of a stowable vehicle seat in accordance with one embodiment of the present invention;

FIGS. 16A-16F are explanatory side views showing an operation procedure at the time of restoring operation of a stowable vehicle seat in accordance with one embodiment of the present invention; and

FIGS. 17A-17C are explanatory side views for explaining operation of a link mechanism at the time of restoring operation of a stowable vehicle seat in accordance with one embodiment of the present invention.

### DETAILED DESCRIPTION OF THE EMBODIMENTS

One embodiment of the present invention will now be described with reference to the accompanying drawings. Needless to say, the members, arrangements, and the like described below do not restrict the present invention, and can be modified and changed variously in light of the teachings of the present invention.

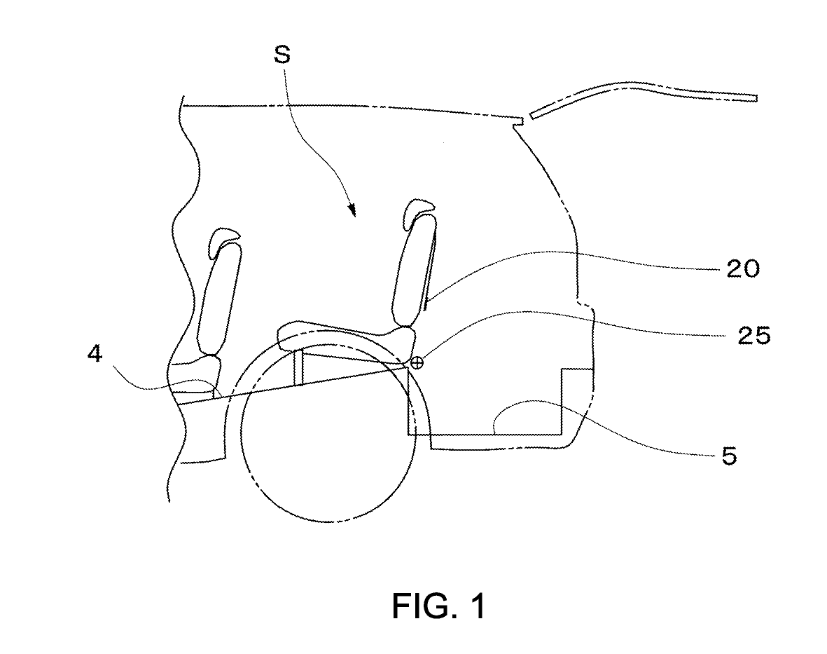

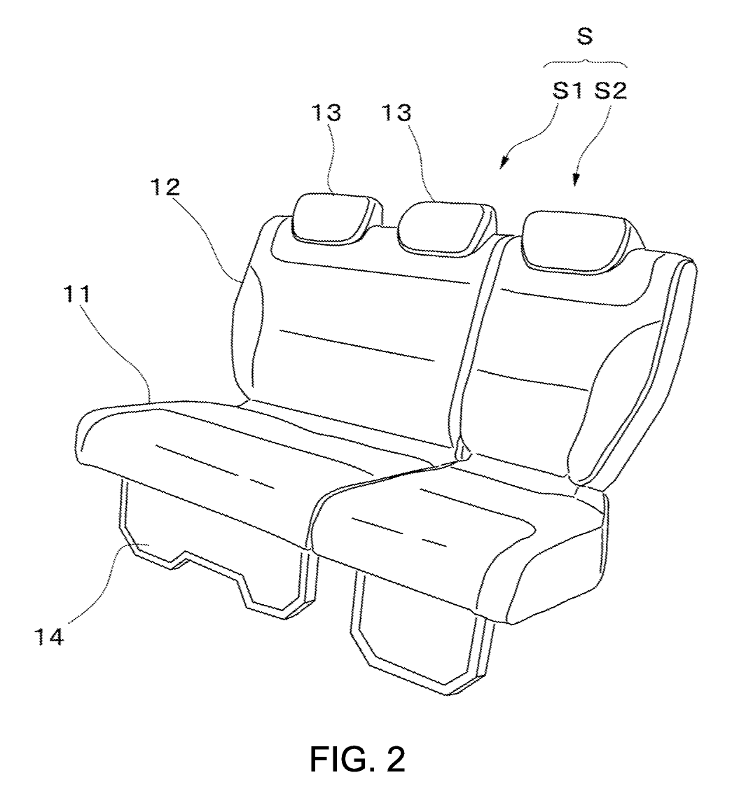

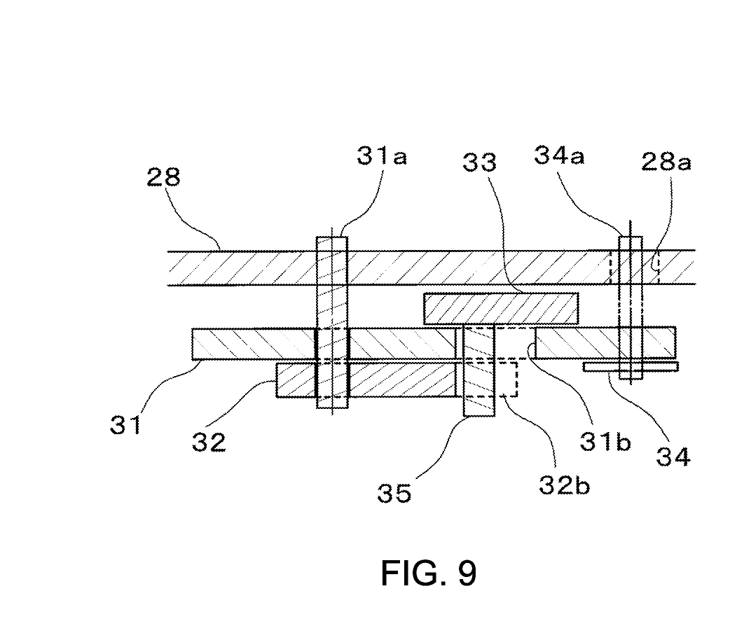

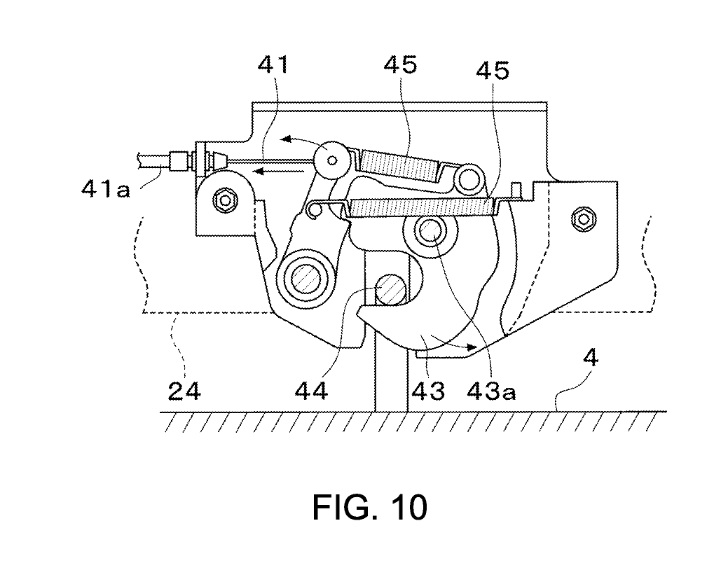

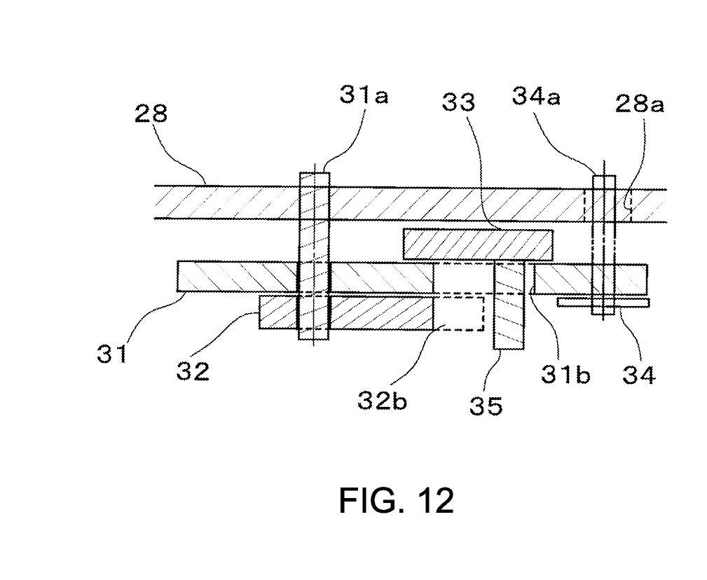

FIGS. 1 to 17 show one embodiment of the present invention. First, the configuration of a seat S, S1 in accordance with this embodiment is explained with reference to FIGS. 1 to 7.

A vehicle equipped with the seat S of this embodiment has three-row seats arranged in the front and rear direction, and the seat of the third row is configured to be stowable. The seat S in accordance with this embodiment relates to the third-row seat. At the rear of the seat S, a stowage recess 5 serving as a stowage area for stowing the seat S is provided in a vehicle body floor 4. On this vehicle, a floor carpet (not shown) is laid throughout almost the entire surface of the vehicle floor 4.

The seat S has three seats in the right and left direction, and is configured by a right seat S1 for two persons, which is located on the right-hand side with respect to the vehicle travel direction, and a left seat S2 for one person.

In the description below, the right-hand side and the left-hand side showing the direction are referred to with respect to the vehicle travel direction.

Also, since the stowage mechanisms and operating methods of the right seat S1 and the left seat S2 are the same, in the explanation below, explanation is given by taking the right seat S1 as the seat S.

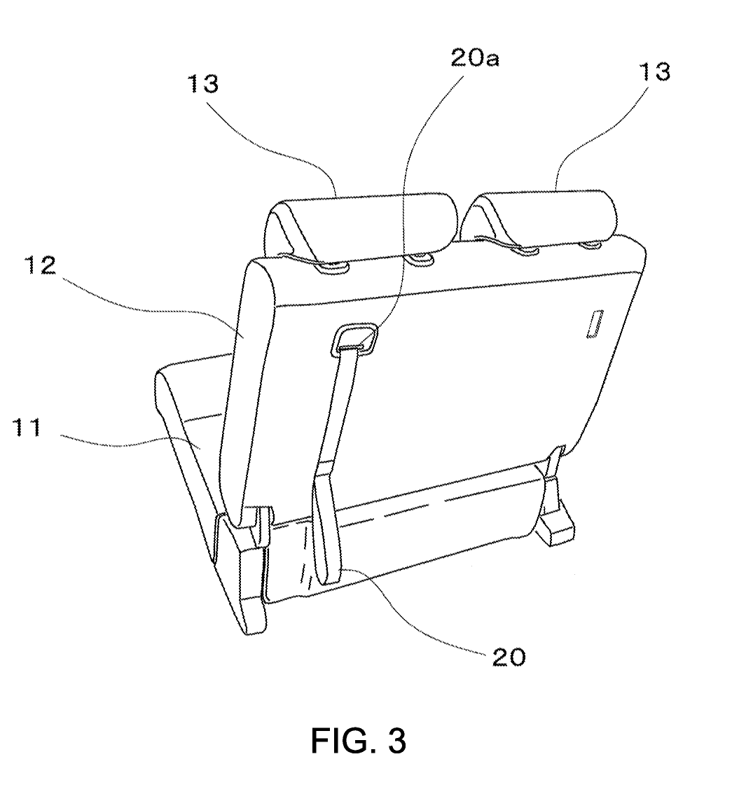

The seat S is made up of a seat cushion 11, a seat back 12, headrests 13, 13 and a front leg 14. Also, as shown in FIG. 3, from the back side of the seat back 12, a strap 20 serving as a single operating element for performing the stowing/restoring operation of the seat S is extended from the back surface side of the seat S to the outside.

For the seat S in accordance with this embodiment, the operating element for the reclining locking releasing mechanism and the leg locking releasing mechanism operated when the stowable vehicle seat is stowed and restored are integrated into one as the strap 20.

The strap 20 is an operating element operated at the time of stowing/restoring operation of the seat S, and is configured so that a flexible wide belt having a length of about 1 m is extended from a strap outlet part 20a to the other side to facilitate operation performed by a passenger. The stowing/restoring operation of the seat S can be performed by the pulling operation of the strap 20, so that the operation load can be reduced as compared with the operation using a lever. In the state in which the stowing/restoring operation of the seat S is not performed, a part of the strap 20 is hooked to a planar fastener on the back surface of the seat back 12. In this embodiment, the strap 20 serving as the operating element is configured to be of a belt form. However, the strap 20 may be formed in a string form or a pulling lever form.

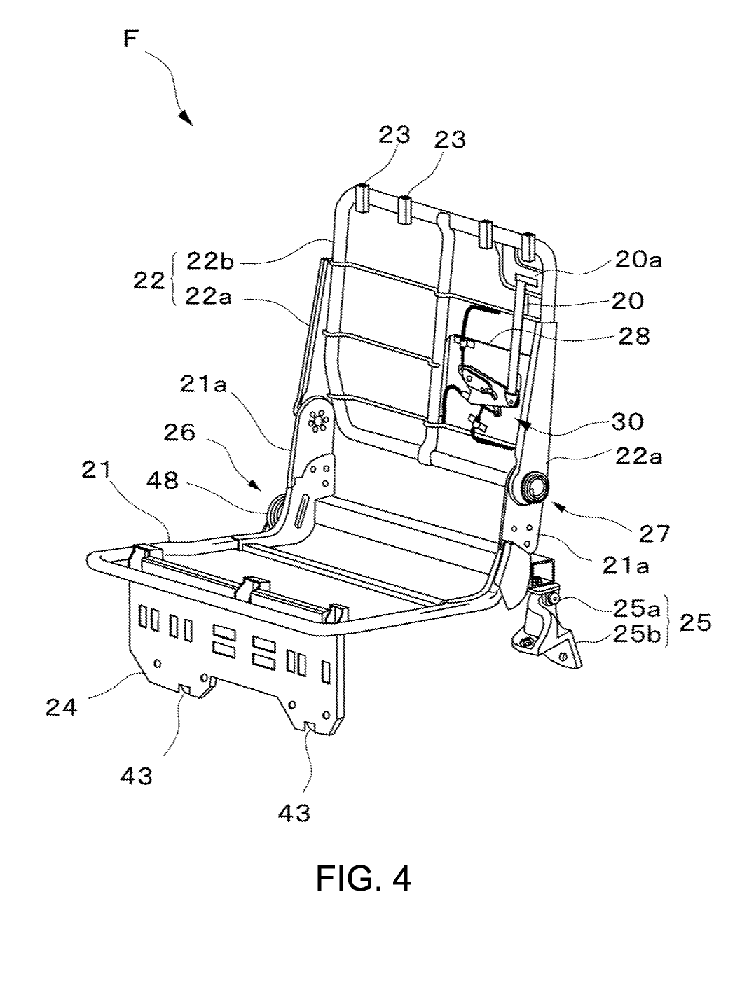

A seat frame F of the seat S shown in FIG. 4 includes a seat cushion frame 21 constituting the seat cushion 11, a seat back frame 22 constituting the seat back 12, and a front leg frame 24. The seat cushion frame 21 and the seat back frame 22 are connected to each other via reclining mechanisms 27, and the seat cushion frame 21 and the vehicle body floor 4 side are connected to each other via seat support parts 25 and 26. Also, in the upper part of the seat back frame 22, pillars for headrest frames (not shown) are disposed via pillar support parts 23.

The seat cushion frame 21 is used to constitute the seat cushion 11 that is covered by a cushion pad, a cover, or the like (not shown) and supports the passenger from the lower side. The front side of the seat cushion frame 21 is supported on the vehicle body floor 4 side by the front leg frame 24. Also, in the rear end part of the seat cushion frame 21, back frame support parts 21a, 21a connected to the seat back frame 22 are provided.

The rear end part side of the seat cushion frame 21 is supported by the seat support parts 25 and 26 to be rotatable in the front and rear direction.

The seat back frame 22 is used to constitute the seat back 12 that is covered by a cushion pad or the like (not shown) and supports the passenger's back from the rear, and in this embodiment, comprises a substantially rectangular frame body. More specifically, the seat back frame 22 is formed by two side frames 22a, 22a which are disposed to be separate in the right and left direction and extend in the up and down direction, and a central frame 22b, which is the substantially rectangular frame body held between the side frames 22a, 22a.

On the seat back frame 22 and the seat cushion frame 21, a stowage locking mechanism 70 (not shown in FIG. 4) is provided.

The lower end part side of the side frames 22a, 22a is connected to the back frame support part 21a, 21a via the reclining mechanism 27.

On the inside of the central frame 22b, which is the frame body, a substantially plate-shaped back plate 28 is disposed along the plane for supporting the passenger's back. On the back plate 28, a link mechanism 30, described below, is provided. Also, the strap outlet part 20a is provided in the upper part of the central frame 22b.

The front leg frame 24 is used to constitute the front leg 14 that is covered by a cover material (not shown) and serves as a second seat support, and is connected to the vehicle body floor 4 side to support the front side of the seat cushion frame 21 as described above. The front leg frame 24 is supported, in the upper part thereof, on the front side of the seat cushion frame 21 to be rotatable in the front and rear direction, and in the lower part of the front leg frame 24, locking claws 43, 43 that are connected to a leg striker 44 provided on the vehicle body floor 4 side to be engageable and disengageable are provided at two places. In this embodiment, the configuration is made such that the locking claws 43 are provided at two places at the right and left. However, the configuration may be made such that either one of the right and left locking claws 43 is provided, or one locking claw 43 is provided at one place in the central portion.

The seat support parts 25 and 26 are formed in a pair at the left and right, and each of the seat support parts 25 and 26 is made up of a rotating shaft 25a, 26a for supporting the seat S to be rotatable in the front and rear direction and a rotating shaft bracket 25b, 26b for mounting the rotating shaft 25a, 26a. In the seat support part 26 on one side of the left and right seat support parts 25 and 26, spiral springs 48 are mounted to urge the seat cushion 11 to the frontward rotating direction.

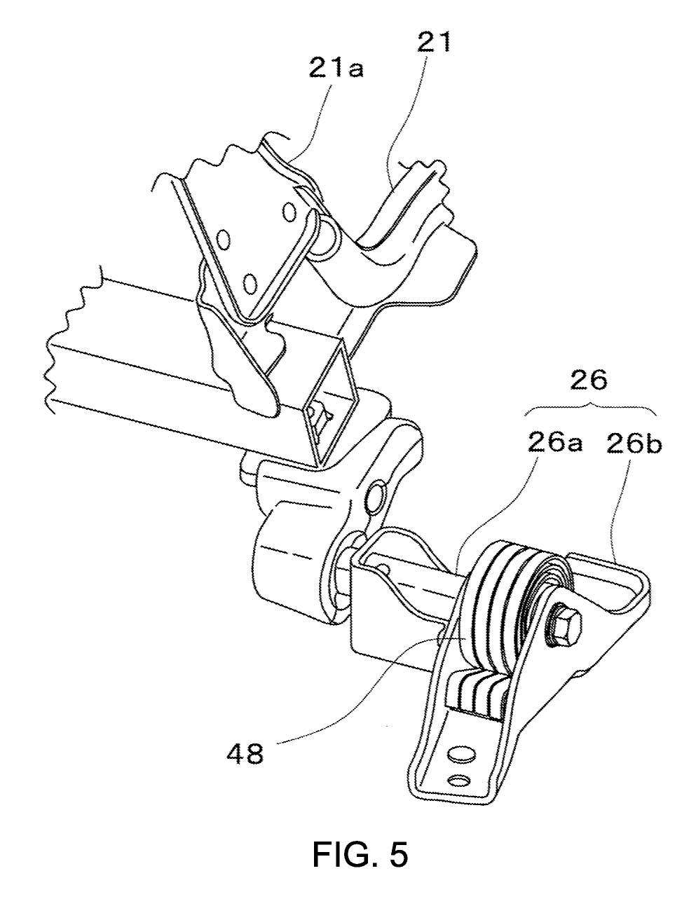

The seat support part 26 is explained with reference to FIG. 5 below.

The configuration is made such that the urging element is provided on one side only of the paired seat support parts 25 and 26 mounted to the rear end part of the seat cushion frame 21. In this embodiment, the side on which the urging element is provided is referred to as the seat support part 26. On the rotating shaft bracket 26b of the seat support part 26, the urging spring serving as the urging element is provided. The urging spring is formed by four spiral springs 48 provided in parallel. For each of the spiral springs 48, the outside end part (external hook) side thereof is locked to the rear side of the rotating shaft bracket 26b, and the inside end part (internal hook) side thereof is locked to the rotating shaft 26a, whereby the seat S side is urged to the frontward rotating direction.

The number of urging spiral springs 48 can be reduced by replacing the spiral springs 48 with spiral springs with a larger spring constant.

The reclining mechanisms 27, 27 are formed in a pair at the right and left. Since the configurations thereof at the right and left are the same, in the explanation below, for convenience, explanation is given by taking one reclining mechanism as the reclining mechanism 27. By the reclining mechanism 27, the side frame 22a and the back frame support part 21a are connected to each other rotatably and foldably.

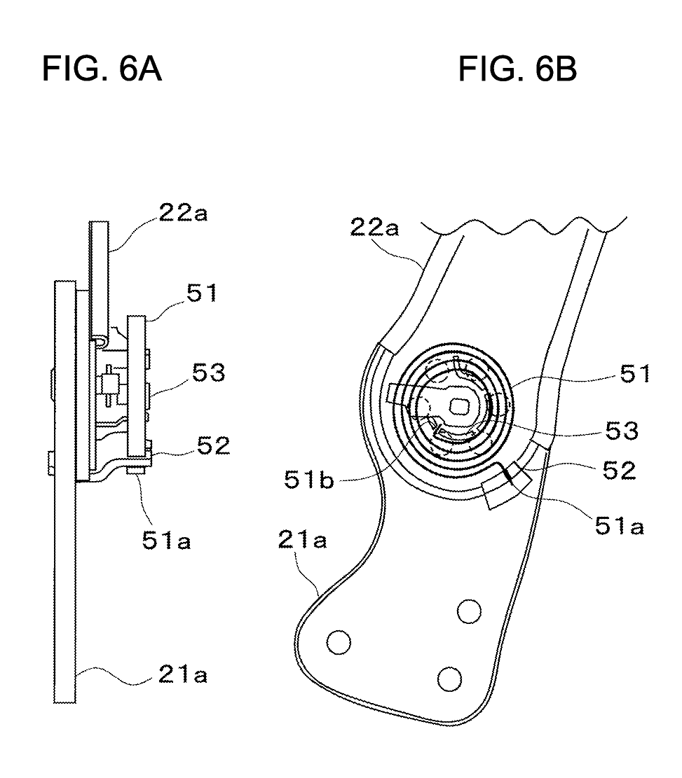

The reclining mechanism 27 is further explained with reference to FIGS. 6A and 6B.

The reclining mechanism 27 is a mechanism for locking the reclining angle of the seat back 12 with respect to the seat cushion 11 by meshing external teeth (not shown) provided on the seat back 12 side with internal teeth (not shown) provided on the seat cushion 11 side. By releasing the meshing of the external teeth with the internal teeth, the locking of the reclining mechanism 27 is released, and thereby a state in which the reclining angle of the seat back 12 can be adjusted is formed. Also, the reclining mechanism 27 is mounted with a spiral spring 51 serving as an urging element of the seat back 12. Therefore, in the state in which the locking of the reclining mechanism 27 is released, the seat back 12 rotates to the urge direction of the spiral spring 51.

The spiral spring 51 is fixed, on both end part sides thereof, to the back frame support part 21a side and the side frame 22a side. Specifically, an external hook (outside end part) side 51a of the spiral spring 51 is locked to be inserted in a slit serving as a notch part or a groove part formed in a first locking part 52 fixed to the back frame support part 21a side. On the other hand, an internal hook (inside end part) side 51b is locked to be inserted in a slit serving as a notch part or a groove part formed in a second locking part 53 fixed to the side frame 22a side. That is to say, since both end part sides of the spiral spring 51 are locked to be inserted, both end part sides serve as fixed ends.

For the spiral spring 51 used in this embodiment, one spiral spring is used for each of the right and left reclining mechanisms 27. However, the configuration of the spring used is not limited to this one. Also, besides the spiral spring 51, a torsion bar, a coil spring, or the like can be used as appropriate.

Since the spiral spring 51 is configured so that both end part sides thereof are fixed ends, and is locked to be unable to rotate, the urge direction of the seat back 12 is not limited to one direction. That is to say, the neutral position of the seat back 12 of the spiral spring 51 can be set at an arbitrary predetermined angle.

In the case where the angle of the seat back 12 with respect to the seat cushion 11 is taken as a “seat back fall-down angle d”, and the seat back fall-down angle d in the state in which the seat back 12 is folded over the seat cushion 11 is set at 0 degrees, the neutral position of the seat back 12 in this embodiment is preferably set at 22.5 degrees or larger of the seat back fall-down angle d.

In the case where the seat back fall-down angle d as the neutral position of the seat back 12 is too small, the height of the direction in which the strap 20 operated to raise the seat back 12 at the time of restoring operation of the seat S is pulled becomes close to the height of the turning shaft, so that an operation load P increases. Therefore, to reduce the operation load P, the seat back 12 must be raised to increase the power point at which the strap 20 is pulled.

However, the region of the seat back fall-down angle d is not limited to the aforementioned one, and can be changed as appropriate.

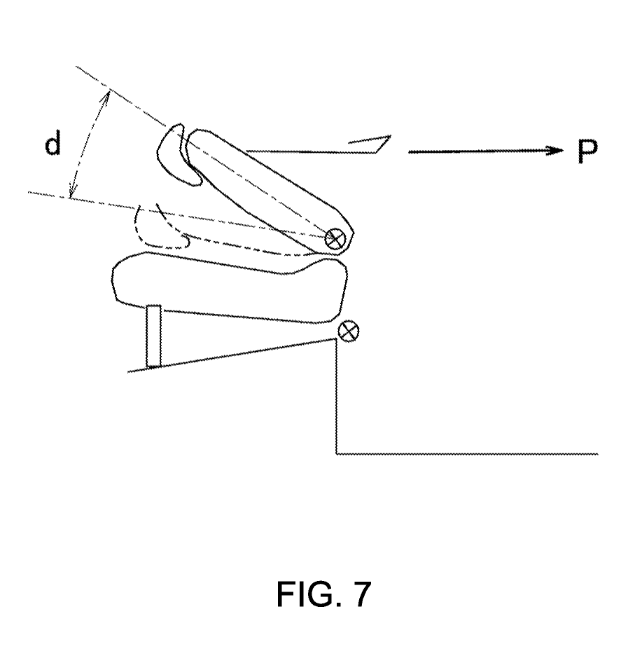

FIG. 7 is an explanatory side view of the seat back fall-down angle d and the operation load P for the seat S.

In the case of the seat S, it is judged through experience that the operation load P at which the passenger feels operation to be easy to perform is preferably about 60 Newtons (N) or lower. Although the operation load P exhibits a value exceeding 100N when the seat back fall-down angle d is 0 degrees, with an increase in the seat back fall-down angle d, the operation load P decreases. When the seat back fall-down angle d was 15 degrees or larger, a good sense of operation was obtained. Therefore, it is desirable that the seat back fall-down angle d in the neutral position of the seat back 12 be 15 degrees or larger. Also, when the seat back fall-down angle d was 22.5 degrees or larger, the operation load P exhibited a value of 60N or lower.

On the other hand, in order to keep low the operation load P at the time when the seat S is locked to the stowage locking mechanism 70 when this seat S is stowed, a lower seat back fall-down angle d in the neutral position is advantageous. Specifically, an angle of 50 degrees or smaller is preferable. Desirably, the angle should be 30 degrees or smaller. That is to say, it is preferable that the neutral position of the seat back 12 be set at a seat back fall-down angle d not smaller than 15 degrees and not larger than 30 degrees, further preferably, not larger than 22.5 degrees.

In the above-described embodiment, both sides of the spiral springs 51, 51 mounted to each of the right and left reclining mechanisms 27, 27 are made fixed ends, and the position in which the spiral springs 51, 51 becomes in a no-load state is set as the neutral position. However, the configuration may be made such that the urge direction of the spiral springs 51, 51 mounted to the reclining mechanisms 27, 27 is made in reverse, and the position in which the urging forces of the spiral springs 51, 51 are balanced is set as the neutral position. In this case, of both end parts of the spiral spring 51, one side can be made a fixed end by being inserted in the locking part, and the other end can be made a hooked end part hooked to a pin or the like to regulate the urge direction to one direction only.

As the spiral spring 51, spiral springs of the falling-down urge side (rearward rotating side) and the returning urge side (frontward rotating side) can be used for the right and left reclining mechanisms 27.

However, the spring used is not limited to the above-described ones. Also, besides the spiral spring 51, a torsion bar, a coil spring, or the like can be used as appropriate.

Also, the configuration can be made such that a plurality of spiral springs 51 are mounted either or both of the right and left reclining mechanisms 27. In this case, the urge directions of the plurality of spiral springs 51 mounted to the reclining mechanisms 27 are made different, and in a position in which the urging forces thereof are balanced, the neutral position of the seat back 12 with respect to the seat cushion 11 can be set.

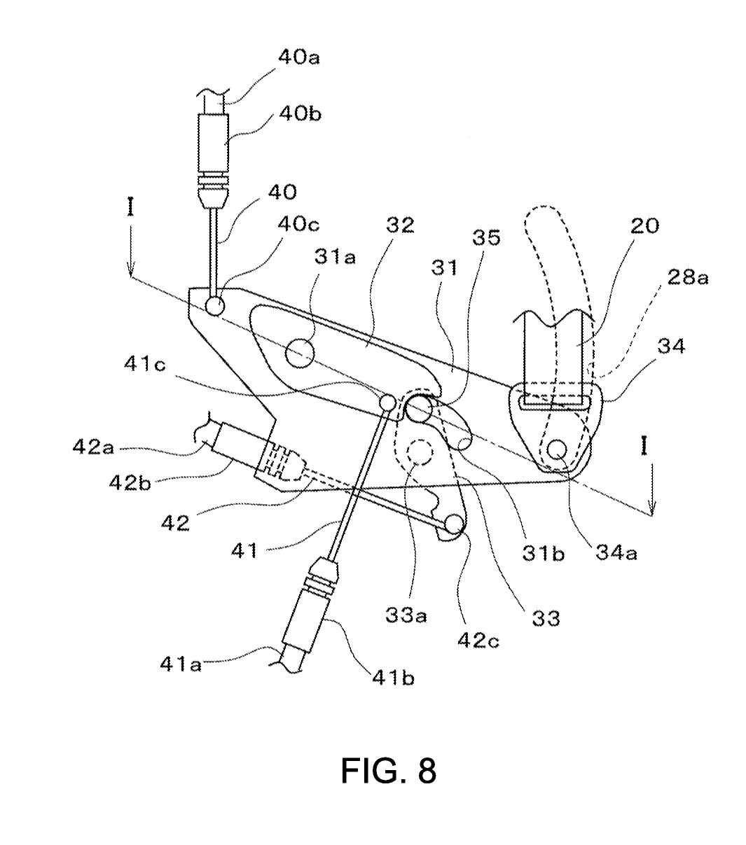

Next, the configuration of the link mechanism 30 is explained with reference to FIGS. 8 to 12.

The link mechanism 30 is connected to the strap 20 operated at the time of stowage and restoration of the seat S, and has a function of appropriately releasing the rotating of the reclining mechanism 27 and the locked state of the front leg 14 to the vehicle body floor 4 in association with the operation of the strap 20 and the state of the seat S. As described above, the link mechanism 30 is formed on the back plate 28.

The link mechanism 30 is configured to have a first link member 31, a second link member 32, and a third link member 33, which are rotatably supported, and a power transmitting member is connected to each of the link members. These link members are configured to be operated in association with each other according to the state between the power transmitting members and the operation between the link members.

As the power transmitting members, there are provided a reclining releasing wire 40 connected to the reclining mechanism 27, the strap 20 serving as the operating element, a leg releasing wire 41 connected to the locking claw 43 of the front leg 14 (the front leg frame 24), and a cancel wire 42 for detecting the fall-down state (folded state) of the seat back 12.

The first link member 31 is a substantially inverse triangular member that is flat in the right and left direction. To a locking part 40c provided on one end part side of the first link member 31, the reclining releasing wire 40 serving as the power transmitting member is locked, and to a locking part 34a provided on the other side of the first link member 31, the strap 20 is locked via a strap connecting member 34 so that the first link member 31 is rotatably supported on the back plate 28 by a first shaft part 31a provided between the locking parts 40c and 34a.

Also, between the first shaft part 31a and the locking part 34a, an arc-shaped elongated hole 31b is formed to draw a circle concentric with a second shaft part 33a, described below.

The other end part sides of the reclining releasing wire 40 locked to the first link member 31 as the power transmitting member and the strap 20 are explained below.

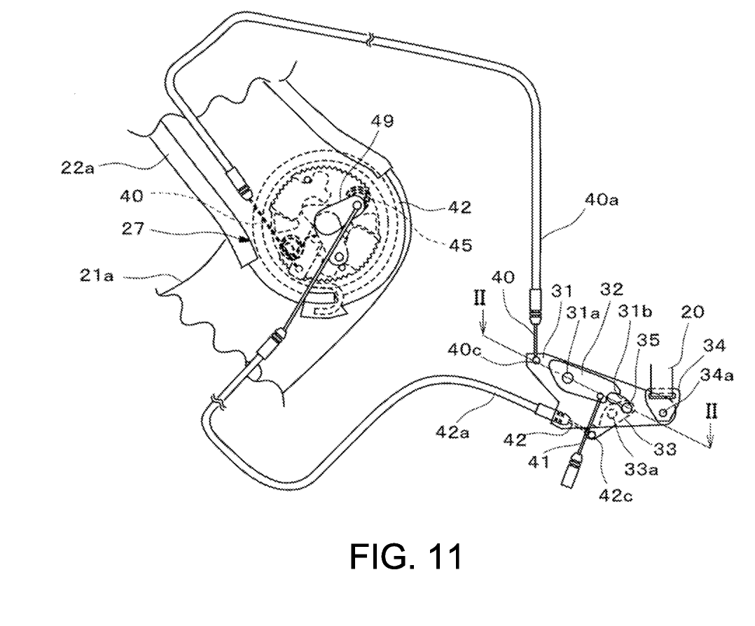

As shown in FIG. 11, the other end part side of the reclining releasing wire 40 locked to the locking part 40c on the end part side of the first link member 31 is guided by a reclining releasing cable 40a and is connected to the reclining mechanism 27 that releases the locked state of rotating of the seat back 12.

The reclining mechanism 27 is a mechanism for releasing the locked state of rotating of the reclining mechanism 27 to make the seat back 12 in a rotatable state when the reclining releasing wire 40 is pulled to the link mechanism 30 side by the operation of the link mechanism 30. The other end part side of the strap 20 connected to the end part side of the first link member 31 via the strap connecting member 34 is extended from the strap outlet part 20a provided on the back surface of the seat back 12 to the outside of the seat back 12 to make the operation performed by the passenger easy. In association with the operation of the strap 20 performed by the passenger, the power (the operating force of the passenger) can be transmitted to the first link member 31.

That is to say, when the strap 20 is pulled, the first link member 31 is rotated, and the locking of the reclining mechanism 27 is released.

The second link member 32 is a substantially rectangular member, and is disposed on the first link member 31.

The end part side on which the reclining releasing wire 40 is mounted is pivotally supported to be rotatable coaxially with the first link member 31 by the first shaft part 31a. On the other end part side, a locking recess 32b that is in contact with a locking protrusion 35, described below, is formed. Between the first shaft part 31a and the locking recess 32b, a locking part 41c to which the leg releasing wire 41 is locked is formed.

The other end part side of the leg releasing wire 41 locked to the second link member 32 as the power transmitting member is explained below.

The other end part side of the leg releasing wire 41 locked to the locking part 41c of the second link member 32 is guided by a leg releasing cable 41a and is connected to a leg locking releasing mechanism serving as an engaging and disengaging assembly. The leg locking releasing mechanism is formed in the front leg 14, and releases the locking to the leg striker 44 on the vehicle body floor 4 side by turning the locking claws 43 connected to the leg releasing wire 41 around a locking claw rotating shaft 43a when the leg releasing wire 41 is pulled to the link mechanism 30 side by the operation of the link mechanism 30. When the leg locking releasing mechanism is released, the seat cushion 11 becomes in a state of being rotatable in the front and rear direction.

The rotating of the locking claw 43 is urged by an urging spring 45 in the direction such that the locking state to the leg striker 44 is maintained.

The third link member 33 is a substantially rectangular member, being disposed between the first link member 31 and the back plate 28, and the central part thereof is rotatably supported on the first link member 31 side by the second shaft part 33a.

To the lower end part side of the third link member 33, the cancel wire 42 is locked via a locking part 42c.

On the upper end part side, the cylindrical locking protrusion 35 serving as the locking part is formed. This locking protrusion 35 is inserted through the arc-shaped elongated hole 31b formed in the first link member 31 and is in contact with the locking recess 32b of the second link member 32, so that the second link member 32 is locked to rotate together with the first link member 31. The locking protrusion 35 is formed to have an outside diameter slightly smaller than the width of the elongated hole 31b. On the other hand, the elongated hole 31b is formed in an arcuate shape to draw a circle concentric with the second shaft part 33a as described above. Therefore, the configuration is made such that the locking protrusion 35 moves along the elongated hole 31b with the rotating of the third link member 33.

The other end part side of the cancel wire 42 locked to the third link member 33 as the power transmitting member is explained below.

As shown in FIG. 11, the other end part side of the cancel wire 42 locked to the locking part 42c of the third link member 33 is guided by a cancel cable 42a and is connected to a locking rib 49 formed in the connecting part between the side frame 22a and the back frame support part 21a. The locking rib 49 is a member provided on the reclining mechanism 27, and is mounted to rotate together with the side frame 22a. That is to say, in this embodiment, the other end part of the cancel wire 42 is locked to the locking rib 49. The other end part side of the cancel wire 42 is configured so that the locking rib 49 pulls the locking part 42c formed in the third link member 33 via the cancel wire 42 in the state in which the seat back 12 is folded, and functions as a detecting element by rotating the third link member 33. That is to say, the reclining assembly has the reclining mechanism 27 and the detecting element.

In this embodiment, the locking rib 49 locked to the other end part side of the cancel wire 42 is formed on the reclining mechanism 27. However, any other locking part may be used as far as the configuration is made such that the cancel wire 42 is operated in the state in which the seat back 12 is folded over the seat cushion 11. Further, the locking rib 49 may be formed in a portion separate from the reclining mechanism 27. In this case, the reclining assembly is configured so that the reclining mechanism 27 and the detecting element are provided in separate portions.

In the state in which the third link member 33 is not rotating, the second link member 32 is locked to the first link member 31 by the locking protrusion 35, and can pull the leg releasing wire 41 by rotating with the rotating of the first link member 31.

When the third link member 33 is rotated, the locking protrusion 35 fixed to the third link member 33 moves along the elongated hole 31b. By the movement of the locking protrusion 35, the locking recess 32b is made to not be in contact with the locking protrusion 35. Therefore, the locking of rotating of the first link member 31 and the second link member 32 is released.

At this time, a state in which the second link member 32 does not rotate even if the first link member 31 is rotated by the operation of the strap 20 is formed, and the leg releasing wire 41 having been locked to the second link member 32 becomes in a state of being not pulled even if the first link member 31 rotates.

That is to say, in the state in which the seat back 12 is folded, the configuration is such that even if the strap 20 is pulled, the locking of the front leg 14 to the vehicle body floor 4 is not released. In other words, by rotating of the third link member 33, a state in which the second link member 32 cannot rotate can be formed.

On the locking releasing mechanism side (the other end part side of the link mechanism 30) to which the reclining releasing wire 40 and the leg releasing wire 41 are connected, the urging spring 45 is provided to urge the reclining releasing wire 40 and the leg releasing wire 41 to the direction of holding in the locked state. Therefore, in the state in which the passenger does not operate the strap 20, concerning the first link member 31 and the second link member 32 as well, the rotating of the link mechanism 30 is urged to the direction such that the strap 20 is pulled downward via the strap connecting member 34.

The locking part 34a of the strap connecting member 34 provided on the first link member 31 pivotally supports the strap connecting member 34 on the first link member 31 to be rotatable, and also the other end side thereof is inserted through a guide hole part 28a formed in the back plate 28. The guide hole part 28a is formed in an arcuate shape to draw a part of a circle concentric with the first shaft part 31a, so that the locking part 34a can move in the guide hole part 28a with the operation of the first link member 31. Also, by adjusting the length of the guide hole part 28a, the upper and lower limits of rotating amount of the first link member 31 can be set.

End part members 40b and 41b, which are end parts on the link mechanism 30 side of the reclining releasing cable 40a and the leg releasing cable 41a for guiding the reclining releasing wire 40 and the leg releasing wire 41, respectively, are fixed onto the back plate 28 by locking members (not shown).

An end part member 42b, which is an end part on the link mechanism 30 side of the cancel cable 42a for guiding the cancel wire 42, is fixed to the first link member 31 by a locking member (not shown).

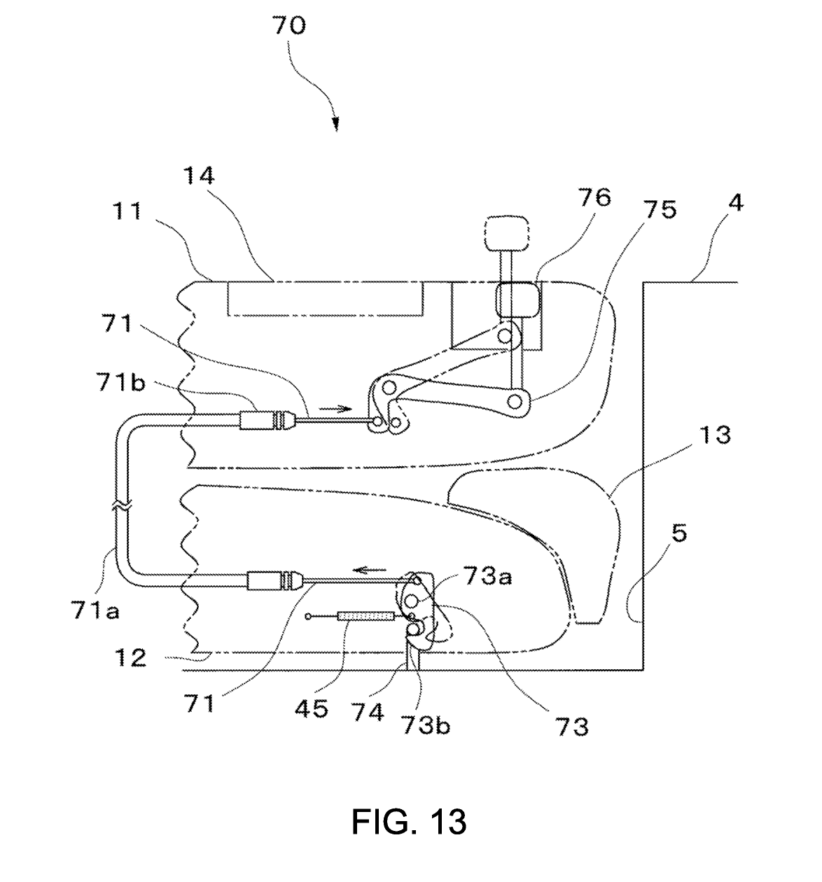

FIG. 13 is an enlarged explanatory side view of the stowage locking mechanism 70.

The stowage locking mechanism 70, which is a locking part for holding the seat S in a state of being stowed in the stowage recess 5, locks a locking claw 73 provided on the back surface side of the seat back 12 to a stowage striker 74 provided in the bottom part of the stowage recess 5.

The stowage locking mechanism 70 is made up of a stowage locking releasing wire 71 for operating the locking claw 73, an urging spring 45 for urging the locking claw 73 to the side of holing the locking, a grip 76 serving as a locking releasing element, and a stowage link member 75 for connecting the grip 76 to the stowage locking releasing wire 71.

When the seat S is stowed, the seat S is locked by being pressed against the stowage recess 5. That is to say, a tilting locking claw tip end part 73b comes into contact with the storage striker 74, and the locking claw 73 turns around a locking claw rotating shaft 73a to a position that locks to the stowage striker 74.

In order to release the locking, the grip 76 provided on the seat cushion 11 side is pulled upward, whereby the locking of the seat back 12 to the storage recess 5 is released. The configuration is made such that by pulling the grip 76, the stowage releasing wire is pulled via the stowage link member 75, whereby the locking claw 73 is turned in the locking releasing direction.

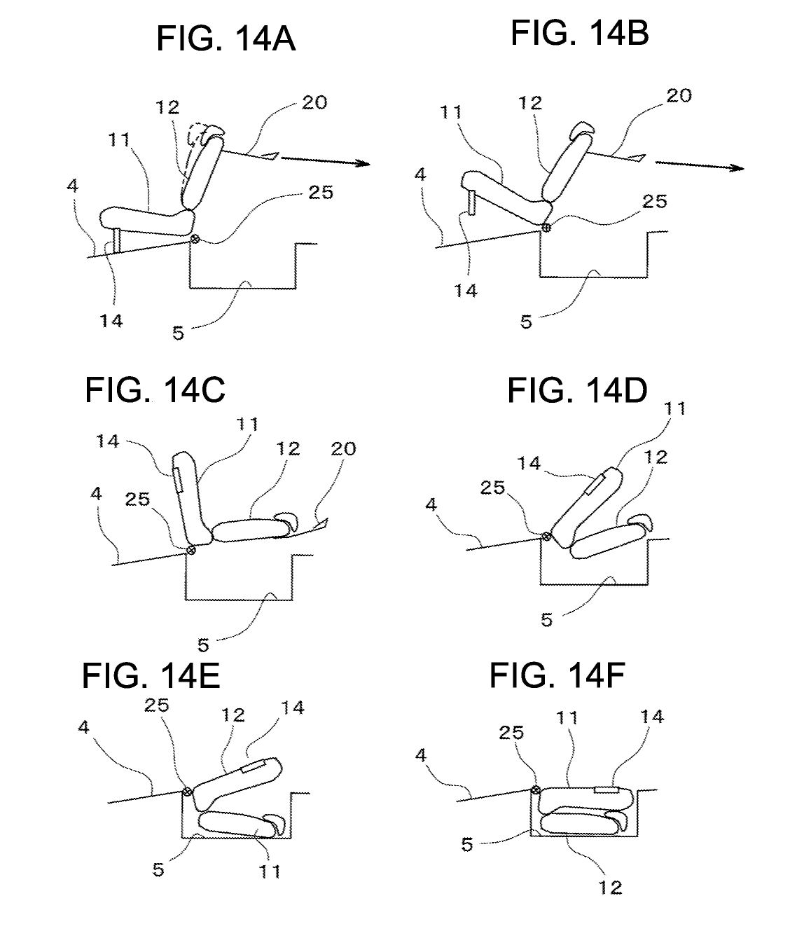

Next, the stowing/restoring operation of the seat S of this embodiment and the operation of the link mechanism 30 are explained with reference to FIGS. 14 to 17.

First, the stowing operation of the seat S is explained with reference to FIGS. 14A to 14F.

FIG. 14A shows the state in which the locking of the reclining mechanism 27 is released. When the passenger pulls the strap 20 to the rear, the locking of the reclining mechanism 27 is released.

At this time, the seat back 12 to which the strap 20 is mounted is being urged to the front direction by the urging spring (the spiral spring 51) mounted on the reclining mechanism 27. Since the configuration is made such that if the strap 20 is pulled against the urging direction, the locking of the locking claws 43 of the front leg 14 is released by a stress lower than the stress such as to fold the seat back 12 to the rear, the locking of the locking claws 43 is released.

FIG. 14B shows the state in which the locking of the locking claws 43 of the front leg 14 has been released. The locking of the locking claws 43 of the front leg 14 is released, so that the seat S can be rotated to the rear.

FIGS. 14C and 14D show the state in which the rearward rotating of the seat S is advanced. By pulling the strap 20 further, the seat S is rotated so that the center of gravity of the seat S goes beyond the middle point, and thereafter is rotated to the rear by its own weight, reaching a stowed state. At this time, the rearward rotating speed of the seat S is decreased by the urging spring (the spiral spring 48) mounted on the seat support part 25, so that the shock caused by the stowage into the stowage recess 5 is buffered.

The seat back fall-down angle d in the neutral position of the seat back 12 is set at 15 to 30 degrees by the spiral spring 51 mounted to the reclining mechanism 27. Therefore, the shock at the time when the seat back 12 is folded over the seat cushion 11 is buffered, and a fear is suppressed that the rearward rotating speed of the seat S is accelerated by the shock at the time when the seat S is folded.

The front leg 14 is folded to the seat cushion 11 side by its own weight with the rotating of the seat S.

FIG. 14E shows the state in which the seat S has rotated rearward to a position of coming into contact with the stowage recess 5. Since the seat back 12 is supported in the neutral position by the urging spring, a complete fall-down state is not reached. Therefore, the seat S must be locked to the bottom part of the stowage recess 5.

FIG. 14F shows the stowage state of the seat S. In this state, in the stowage locking mechanism 70, the locking claw 73 disposed on the back surface of the seat back 12 is locked to the stowage striker 74 provided in the bottom part of the stowage recess 5. The stowage locking mechanism 70 is locked by pressing the seat S against the stowage recess 5. In this state, the opening part of the stowage recess 5 forms a flat surface integrally with the back surface of the seat cushion 11, so that a spacious cargo room is secured.

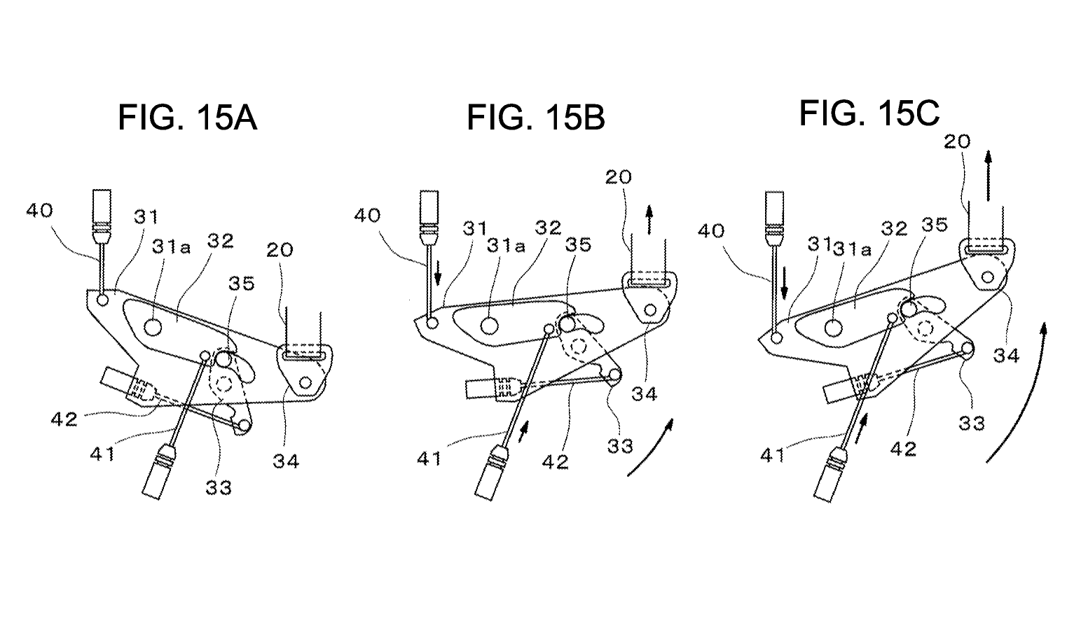

The operation of the link mechanism at the time of the above-described stowing operation of the seat S is explained with reference to FIGS. 15A, 15B and 15C.

FIG. 15A shows the state of the link mechanism 30 at the time when the seat S is set (refer to FIG. 14A). This state is a state before the strap 20 is operated by the passenger. This state of the link mechanism 30 is referred to as the original position.

FIG. 15B shows the state of the link mechanism 30 at the time when the locking of the reclining mechanism 27 is released (see FIG. 14B). This state is a state in which the strap 20 is pulled slightly to the rear. The first link member 31 is rotated in the direction of being pulled by the operation of the strap 20. Therefore, the reclining releasing wire 40 is pulled with the rotating, and the locking of the reclining mechanism 27 is released. At this time, the seat back 12 is in a state of being raised with respect to the seat cushion 11. Therefore, the cancel wire 42 is not pulled, and the second link member 32 rotates together with the first link member 31, whereby the leg releasing wire 41 is also pulled. However, setting is made so that the locking of the locking claws 43 for connecting the front leg 14 to the vehicle body floor 4 side is not released by the pulling amount in this state, so that the locking of the leg is kept.

FIG. 15C shows the state of the link mechanism 30 at the time when the locking of the reclining mechanism 27 and the locking claws 43 of the front leg 14 has been released (see FIGS. 14C and 14D), showing the state in which the strap 20 is further pulled. Compared with the state shown in FIG. 15B (see FIG. 14B), the first link member 31 is also rotated greatly by strongly pulling the strap 20. With this rotating, the reclining releasing wire 40 and the leg releasing wire 41 are pulled further. At this time, the locking of the leg is released.

After the seat S has been stowed, when the operation of the strap 20 is stopped, the state shown in FIG. 15A is restored by the urging spring 45 mounted on the locking releasing mechanism side (the other end part side of the link mechanism 30) to which the reclining releasing wire 40 and the leg releasing wire 41 are connected. However, since the seat back 12 is stowed in a state of being folded over the seat cushion 11 (see FIG. 14F), the cancel wire 42 is pulled, and the third link member 33 is still held in a state of being rotated.

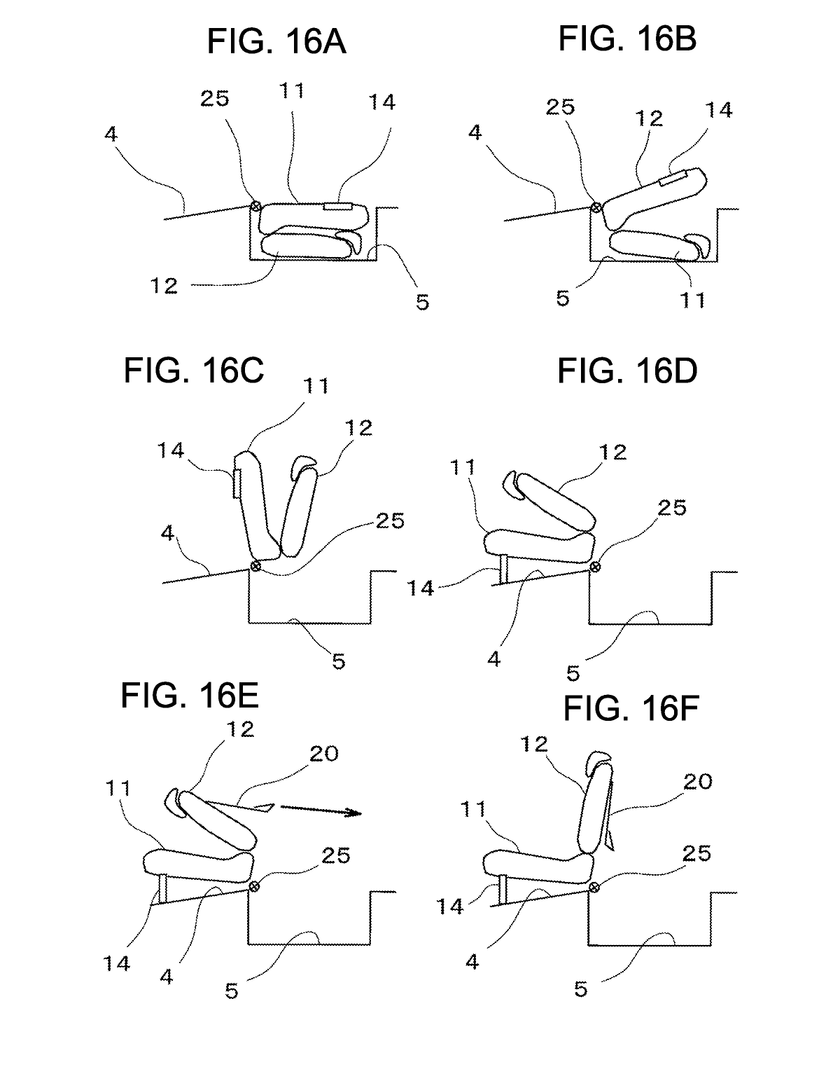

Next, the restoring operation of the seat S is explained with reference to FIGS. 16A to 16F.

FIG. 16A shows the state in which the seat S has been stowed by being locked by the stowage locking mechanism 70.

FIG. 16B shows the state in which the locking of the seat S to the stowage recess 5 of the stowage locking mechanism 70 has been released. By the locking releasing of the stowage locking mechanism 70, a state in which the seat back 11 is opened to the seat back fall-down angle d in the neutral position by the urging of the spiral spring 51 of the reclining mechanism 27 is reached.

FIG. 16C shows the state at the time when the seat S is rotated to the front. With the forward rotating of the seat S, the front leg 14 is rotated by its own weight and is deployed downward.

FIG. 16D shows the state in which the locking claws 43 of the front leg 14 of the seat S have been locked to the vehicle body floor 4 side. The locking claw 43 is locked to the leg striker 44 on the vehicle body floor 4 side by the pressing caused by the own weight of the seat S. At this time, the seat back 12 is in the state of being located in the neutral position by the spiral spring 51 provided on the reclining mechanism 27, and has a seat back fall-down angle d of 15 to 30 degrees.

FIG. 16E shows the operation for pulling the strap 20 to the rear from the state in which the locking claws 43 of the front leg 14 of the seat S are locked to the leg striker 44 on the vehicle body floor 4 side. At this time, since the seat back 12 is supported in the neutral position, the seat back 12 can be raised by a low pulling load as compared with the fall-down state. Also, the locking claws 43 are kept in a locked state, so that only the seat back 12 can be raised with respect to the seat cushion 11.

FIG. 16F shows the state in which the restoring operation of the seat S has been finished.

After the seat S in the stowage state in which the seat back 12 is folded has been rotated to the front, the seat S can be restored merely by pulling the strap 20 to the rear by the passenger.

The operation of the link mechanism at the time of the above-described restoring operation of the seat S is explained with reference to FIGS. 16A-F, 17A, 17B, and 17C.

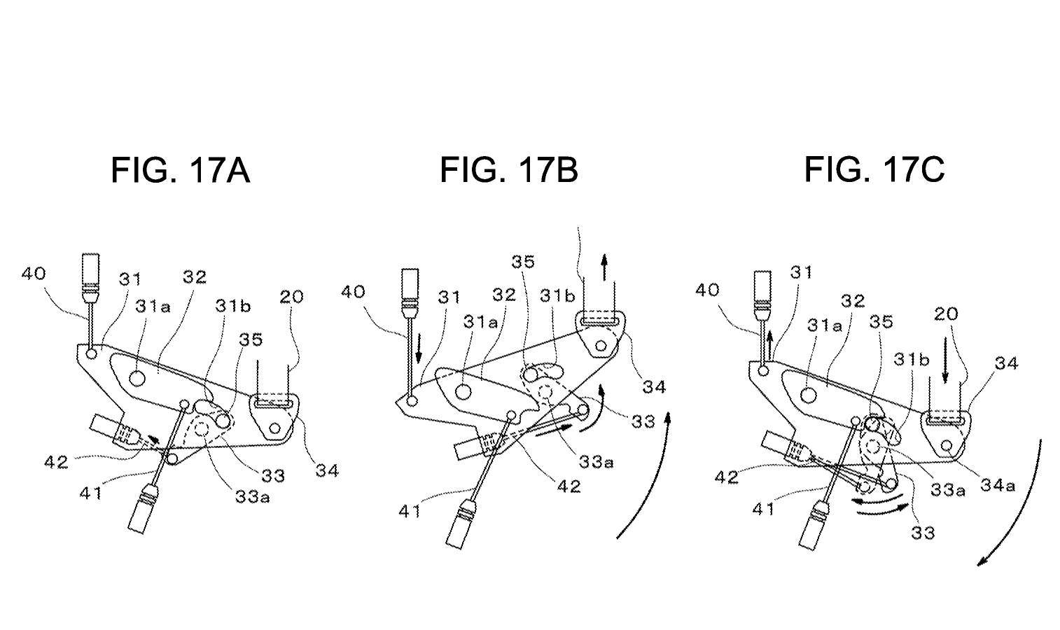

FIG. 17A shows the state of the link mechanism 30 at the stage at which the seat S is rotated from the stowage state of the seat S (see FIG. 16A) and the locking claws 43 are locked to the vehicle body floor 4 side (see FIG. 16D). This stage is a stage before the strap 20 is operated by the passenger. Since the operation is performed in the state in which the seat back 12 is folded or in the neutral position of urging, the state in which the cancel wire 42 is pulled and the third link member 33 is rotated is held.

FIG. 17B shows the stage at which the strap 20 is pulled slightly to the rear to raise the seat back 12 (see FIG. 16E). By the operation of the strap 20, the first link member 31 is rotated. With this rotating, the reclining releasing wire 40 is pulled, and thereby the locking of the reclining mechanism 27 is released, so that the seat back 12 can be rotated to the rear. At this time, since the locking protrusion 35 moves together with the third link member 33, even if the first link member 31 rotates, the second link member 32 is not locked to the first link member 31 and is in a state of being unable to turn.

Also, with the raise of the seat back 12, the rotating amount of the third link member 33 decreases. However, the third link member 33 rotates exceeding the rotating range in which the locking protrusion 35 comes into contact with the second link member 32, so that the locking recess 32b of the second link member 32 is kept in a state of not being locked to the first link member 31. Therefore, the state in which the locking of the locking claws 43 for connecting the front leg 14 to the vehicle body floor 4 side is not released is held, so that the seat back 12 can be raised with respect to the seat cushion 11 merely by pulling the strap 20.

FIG. 17C shows the state in which the restoring operation of the seat S has been finished (see FIG. 16F). When the rearward pulling operation of the strap 20 is stopped, the position of the first link member 31 is also returned to the original position by the urging from the reclining releasing wire 40 and the leg releasing wire 41. At this time, since the seat back 12 is raised with respect to the seat cushion 11, the third link member 33 is in a state of not being pulled by the cancel wire 42. Therefore, even by a minute stress, the third link member 33 can be rotated. The second link member 32 is also returned to the original position again and is locked to the first link member 31, and the link members of the link mechanism 30 are restored to the state of original position.

According to the stowable vehicle seat S in accordance with various embodiments of the present invention, the spiral spring 51 for urging the seat back 12 to fold the seat back 12 to the seat cushion 11 side with a predetermined angle with respect to the seat cushion 11 is mounted on the reclining mechanism 27. Thereby, a shock produced when the seat back 12 is folded over the seat cushion 11 can be buffered. Therefore, shock noise is reduced, and a sense of security at the time of seat arrangement can be improved. Also, when the seat back 12 is folded during the stowage rotating of the seat, the acceleration of rotating speed caused by the shock at the time of folding can be reduced.

Furthermore, since the seat back 12 is raised by the pulling operation of the strap 20 from the state of tilting with the predetermined angle with respect to the seat cushion 11, the operation load can be reduced.

In this embodiment, the third-row vehicle seat divided into the right and left has been explained as a specific example. However, the seat type is not limited to this type. Needless to say, the same configuration can be applied to a long bench type seat formed integrally, a passenger seat adjoining the driver's seat, and any other rear seat.

Also, in this embodiment, the stowable vehicle seat S in which the stowing/restoring operation means is integrated into the strap 20 has been explained. However, the present invention can be applied to a seat having a strap and a lever as the operating element.

### TABLE OF REFERENCE CHARACTERS

S, S1 seat
F seat frame
d seat back fall-down angle
P operation load
S1 right seat
S2 left seat
4 vehicle body floor
5 stowage recess
11 seat cushion
12 seat back
13 headrest
14 front leg
20 strap
20a strap outlet part
21 seat cushion frame
21a back frame support part
22 seat back frame
22a side frame
22b central frame
23 pillar support part
24 front leg frame
25, 26 seat support part
25a, 26a rotating shaft
25b, 26b rotating shaft bracket
27 reclining mechanism
28 back plate
28a guide hole part
30 link mechanism
31 first link member
31a first shaft part
31b elongated hole
32 second link member
32b locking recess
33 third link mechanism
33a second shaft part
34 strap connecting member
34a, 40c, locking part
41c, 42c
35 locking protrusion
40 reclining releasing wire
40a reclining releasing cable
40b, 41b, end part member
42b, 71b
41 leg releasing wire
41a leg releasing cable
42 cancel wire
42a cancel cable
43, 73 locking claw
43a, 73a locking claw rotating shaft
43b, 73b locking claw tip end part
44 leg striker
45 urging spring
48, 51 spiral spring
49 locking rib
51a external hook
51b internal hook
52 first locking part
53 second locking part
70 stowage locking mechanism
71 stowage locking releasing wire
71a stowage locking cable
74 stowage striker
75 stowage link member
76 grip

1-5. (canceled)

6. A stowable vehicle seat comprising:
a seat support for supporting the rear part side of a seat cushion to be rotatable with respect to a vehicle body floor;
an engaging and disengaging assembly for detachably mounting a front part side of the seat cushion to the vehicle body floor;
a seat back mounted in a foldable manner to the seat cushion via a reclining assembly; and
an operating element provided on the back surface of the seat back to pull the seat back to the rear,
wherein
the reclining assembly has an urging element which urges the seat back to a direction such that the seat back is folded to a seat cushion side, and holds the seat back in a position with a predetermined angle with respect to the seat cushion, and
the predetermined angle is 15 to 30 degrees.

7. The stowable vehicle seat according to claim 6, wherein the urging element is a spiral spring, and both ends of the spiral spring serve as fixed ends.

8. The stowable vehicle seat according to claim 6, wherein:
the urging element is provided on both sides of the seat back, and one-side urging element urges the seat back to a frontward rotating direction, and the other-side urging element urges the seat back to a rearward rotating direction, and
the urging force in the frontward rotating direction and the urging force in the rearward rotating direction are balanced in a position with the predetermined angle.

9. The stowable vehicle seat according to claim 6, wherein:
the urging element comprises of a plurality of urging springs whose urge directions are different, and
a plurality of urging forces having different urge directions of urging springs are balanced in a position with the predetermined angle.
